(19) United States
(12) Patent Application Publication
(10) Pub. No.: US 2023/0291767 A1
(43) Pub. Date: Sep. 14, 2023

(54) Method of Detect an Email Phishing Attempt or Fraudulent Email Within an Email Domain

(71) Applicant: William Michael Pearce, Toronto (CA)

(72) Inventor: William Michael Pearce, Toronto (CA)

(21) Appl. No.: 18/117,456

(22) Filed: Mar. 5, 2023

(51) Int. Cl. H04L 9/40; G06Q 10/107

(52) U.S. Cl. CPC H04L 63/1483; G06Q 10/107

(57) ABSTRACT

Herein is disclosed a method of verifying the authenticity of emails sent within an email domain from a sender to a recipient, the emails each having a sender’s email address, a receiver’s email address, and a user-accessible field for receiving content. The content of the user-accessible field is visible to the recipient upon opening an email inbox in the second email application. The method includes the steps of first identifying the receiver for an email to be sent by the sender. A current sequence marker for the receiver is then generated. The current sequence marker represents a next sequence identifier in a sequence of emails between the sender and the receiver. The current sequence marker is then inserted into the user-accessible field of the email and the email is then sent.

### CROSS-REFERENCE TO RELATED APPLICATION

This is a continuation-in-part of U.S. Application No. 16/399,321 filed Apr. 30, 2019, the entirety of which is incorporated herein by reference.

### BACKGROUND OF THE INVENTION

Modern enterprises, organizations, groups, businesses and corporations of all types and sizes rely on internal email communications (“corporate email”) to manage projects, allow company personnel in different physical locations to collaborate, disseminate corporate news and policies, and for many other purposes. Typically, a company’s email service (“email domain”) is provided through one or more email servers that facilitate the hosting and the forwarding and exchange of email between staff members. These servers may be under the direct control of the company, or may be furnished through a third party contracted for the purpose. In either case, the effect is the same: the provision of email service within the corporate environment, eliminating the need for staff to use external email providers such as Gmail or Hotmail in order to communicate with each other.

It is beneficial for businesses to assist their personnel with identifying fraudulent emails and help them not be deceived by emails that appear to be legitimate but that are actually phishing attempts, spear-phishing attempts, or other fraudulent emails originating from bad actors with nefarious intents and purposes, such as (i) emails with a forged sender address that is spoofed to appear to come from another email sender, or (ii) clone phishing attempts where an attachment or website link within an email is replaced with a malicious version of the email that claims to be a resend of the original or an updated version to the original, or (iii) other email phishing and fraudulent email attack techniques.

These types of emails typically originate from outside the company and are routed to the company’s email domain by the Simple Mail Transfer Protocol (“SMTP”) and other standards or proprietary methods for transporting email, as per rules set within the email domain. Attempts to impersonate or masquerade as legitimate intra-domain email traffic can evade the conventional filters in the email domain and have the potential to arrive without detection in the in-boxes of targeted email recipients unless a system such as the present invention is in place.

An innovation that would assist in identifying potential phishing attempts and fraudulent emails within a company’s internal email traffic would be a benefit. Any email sender would benefit from this innovation, but businesses with their own email domains, in particular, would benefit by increasing the safety and security of their email environment against phishing attempts and fraudulent emails, thus allowing their staff to communicate more freely and reducing their concerns about the inadvertent disclosure of company information that might be sensitive, proprietary, subject to legal restrictions, or otherwise inappropriate for dissemination outside the company.

### SUMMARY OF THE PRESENT INVENTION

The present invention overcomes the disadvantages of the prior art by providing a method of verifying the authenticity of emails allegedly sent between parities in the same email domain by verifying the sequential history of the email correspondence between the parties. The parties are each coupled to a secure network. Each of the parties have an email send/receive application which is coupled to an email processing application (email server application) located on a server on the secure network. The email processing application handles the delivery of the emails between the parties. The emails each have a sender’s email address, a receiver’s email address, and a user-accessible field such as the subject field. The email addresses each have a name portion and a domain portion in the form of: name@domain.com. All of the parties have identical domain portions (eg. domain.com), The method of the present invention includes providing each of the parties with an email send/receive application coupled to a secure network having a server with an email processing application thereon. The method further includes the steps of identifying the receiver for an email to be sent by the sender and then generating a current sequence marker for the receiver. The current sequence marker represents a next predicted sequence identifier in a sequence of emails between the sender and receiver. For example, if the sequence of emails between the sender and receiver includes 76 messages and the sequence marker is configured to be a numeric integer, then the last sequence identifier used could be 76 in which case the next sequence identifier (76 +1, or 77) would result in the current sequence marker being 77. The next step in the method is to insert the current sequence marker into the user-accessible field of the email and then sending the email to the recipient. Preferably the sequence marker is formed from a sequence of alphanumeric characters which are human readable. Preferably the sequence marker is inserted into the subject line of the email allowing the receiver to verify the presence and veracity of the sequence identifier without having to open the email.

With the foregoing in view, and other advantages as will become apparent to those skilled in the art to which this invention relates as this specification proceeds, the invention is herein described by reference to the accompanying drawing forming a part hereof, which includes a description of the preferred typical embodiment of the principles of the present invention.

### DESCRIPTION OF THE DRAWINGS

FIG. 1 is a schematic view of the system of the present invention showing the system of the present invention being used to send an email from a Sender A to a Recipient B.

FIG. 2 is a schematic view of the system of the present invention being used to send an email.

FIG. 3 is a schematic view of the system of the present invention being used to receive an email.

In the drawings like characters of reference indicate corresponding parts in the different figures.

### DETAILED DESCRIPTION OF THE INVENTION

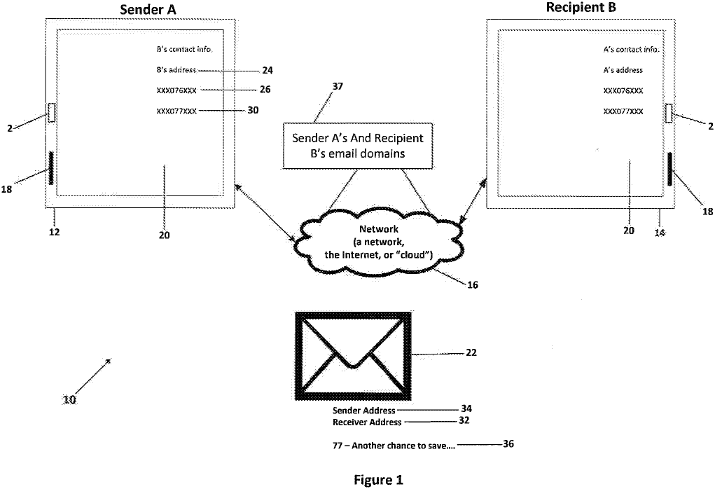

Referring firstly to FIG. 1, the present invention relates to the exchange of emails between users in an organization which is set up to send email messages in bulk such as a public or private company, a government agency, an association, an educational institution, an email service provider or any other email network where all of the users have email addresses having the same email domain (hereafter referred to as the Company). The Company may also include a web-based email service provider, which provides web-based email addresses to a plurality of remote users all with the same email domain. Such web-based email service providers include Yahoo Mail, Gmail, Hotmail and others. The system of the present invention, shown generally as item 10, consists of two email-capable computing devices 12 and 14 in communication with each other via a secure network 16. Network 16 is furnished by the Company for the use of its employees (users) and for other corporate purposes. Network 16 preferably includes a server 100 having an email processing application 102 configured to process email messages between senders and receivers. Network 16 could be a telecom network or cellular data network, or the internet, but preferably network 16 consists of a secure network for users all sharing the same email domain. In the case of user’s using a web-based email address, the network 16 is rendered secure by the requirement of the users to supply login information such as a name and password in order to be logged into the network.

Network 16 is capable of facilitating Simple Mail Transfer Protocol (RFC-5321) for email using Transmission Control Protocol (“TCP”), or other standards or proprietary methods of transporting email, that can send Sender A’s email 22 to the Company’s email domain 37 via the email processing application 102. The Company’s email domain 37 then forwards Sender A’s email 22 via Network 16, again using Simple Mail Transfer Protocol or other standards or proprietary methods of transporting email, to Recipient B’s email application 18.

The Company’s email domain 37 incorporates server 100 and application 102 which are processes compliant with the respective RFC protocols and standards for email source 20 contains data about email contacts, and also contains data about the history of previously sent email messages between authorized users of the Company’s email domain 37. Data source 20 is preferably located on server 100; however, it may also be present on each of computing devices 12 and 14. It is essential that data source 20 contains the contact information of recipients and be operative for the storage and retrieval of sequence identifier 26 for each recipient. Within the present invention, data source 20 could be operative in several forms, including (i) a traditional relational database such as Microsoft™ SQL Server; or (ii) a delimited text file database containing the contact information of recipients and sequence identifier 26 for each recipient; or (iii) a data file containing the contact information of recipients and sequence identifier 26 for each recipient; or (iv) a record of previously sent emails (hereinafter referred to as the “email history”) stored in their native format within, or otherwise accessible by Sender A, Sender A’s email application 18, and process 2; or (v) some other record of, or copy of, the email history that contains the contact information of recipients and sequence identifier 26 for each recipient.

Regardless of whether data source 20 is a traditional database, a data file, or an email history, it is accessible by and interoperable with the other components of the present invention, as described herein. Data source 20 includes data about the components of previously sent emails from Sender A to email recipients within the Company’s email domain 37, and may also include the full or partial text and other data (e.g., MIME types) that comprise previously sent emails, including (i) email header fields such as subject line 36 and recipient email address 24, and (ii) the message body of previously sent email messages. Regardless of where data source 20 resides, or whether data source 20 is a traditional database or another form of accessible email history, its purpose is to contain information about previously sent emails, including the email addresses 26 of email recipients and sequence identifier 26 for each recipient, or next sequence marker 30 for each recipient, or both sequence identifier 26 and next sequence marker 30 for each recipient.

When used in the present invention, if data source 20 is an accessible email history of previously sent emails within the Company’s email domain 37, the contact information of recipients and also sequence identifier 26 is retrievable or discernible. For example, by reading the email history, such as those found in a data folder of previously sent emails within email application 18 or located somewhere else on computing device 12, Sender A (manually) or process 2 (programmatically) could discern what the next sequence marker 30 would be.

Sender A’s computing device 12 is a network 16 enabled device such as a desktop or laptop computer, a smartphone, tablet, smart TV, or another type of device. Computing device 12 uses email application 18, and possibly also process 2, to send emails to correspondents within the Company, such as Recipient B. Email application 18 may reside on the local computing device 12 or a local server, or be accessible via the network 16 (the “internet” or “cloud”). Computing device 12 and email application 18 also have access to a data source 20 (as a database or an accessible email history) that may reside on the local device 12, or a local server, or a local network, or somewhere within the cloud, or on the Company’s email domain 37. Regardless of where data source 20 resides, whether it takes the form of a traditional database or an accessible email history, or how data source 20 components are accessed, data source 20 is operatively coupled to email application 18.

In any arrangement of data source 20 (as a database or an accessible email history) and email application 18, computing device 12 is configured to send email message(s) 22 from Sender A to Recipient B, and more particularly between computing devices 12 and 14 which are operated or otherwise controlled by Sender A and Recipient B, respectively, within the Company’s email domain 37. Receiver B’s computing device 14 is a network- 16 -enabled device such as a desktop or laptop computer, a smartphone, tablet, smart TV, or another type of device. Receiver B’s computing device 14 has access to email application 18 which is part of the Company’s email domain 37.

Names of email message recipients, email address(es) 24 and other relevant information about a plurality of contacts are stored in data source 20 (as a database or an accessible email history). Data source 20 is operatively coupled to sequence identifier 26. The function of sequence identifier 26 is to enumerate each email communication from Sender A to each of Sender A’s individual recipient contacts and to maintain a component of data source 20 (as a database or an accessible email history) for each contact within the Company’s email domain 37, such that every successive email from Sender A to each of its such contacts is identified by the next value in a predictable sequence that is, preferably, intuitively known and understood in the recipients’ language and/or culture. In the example in FIG. 1, this predictable sequence consists of the standard Arabic whole numbers, and the number 76 represents the most recent sequence marker from the emails that have previously been sent from Sender A to Recipient B, and in this example the number 77 represents the next sequence marker 30 that would be used in a future email being sent from Sender A to Recipient B. Since the present invention has been designed to facilitate human recognition and human convenience, in this embodiment Sender A’s sequence identifier 26 for its email correspondence with Recipient B consists of a simple incrementing Arabic numerical sequence. (In the first email communication from Sender A to Recipient B, a starting email sequence number would have to be used. This starting sequence number could be the Arabic numeral 1 or could be another number used to start a sequence.)

Recipient B may notice that the sequence marker for the most recent email correspondence was 76, and that, therefore, the sequence marker for the next legitimate and expected email from Sender A should be 77.

Alternative sequences from the sender’s and recipient’s language and culture would also operate effectively as other embodiments within the present invention: for example, Roman numerals, an alphabet, or a sequence derived from the words to a familiar poem or song. Another embodiment may utilize Multipurpose Internet Mail Extensions (“MIME”) types. Many email applications 18 can now be augmented with MIME types to support multimedia messages, and therefore would be able to expand the range of potential sequence markers significantly: for example, pictures or icons could be used to display a recognizable sequence. Internet Message Format (“IMF”) has been developed in step with Simple Mail Transfer Protocol and is standardized in RFC-5322. IMF is the standard syntax defined by the Internet Engineering Task Force (IETF) for the message bitstream when moving email messages from one computing device to another. As such, it is highly adopted and interoperable with many toolsets and applications. RFC-5322 Section 2.2, Header Fields, states: “Header fields are lines beginning with a field name, followed by a colon (“:”), followed by a field body and terminated by CRLF” and “Each header field is logically a single line of characters, comprised of the field name, the colon, and the field body.”

In this embodiment of the present invention, email senders also use process 2, which is an application or script used in conjunction with email application 18 to create and send emails to recipients within the Company’s email domain 37. Process 2 may be located on computing devices 12 and 14 or on server 100.

Therefore, for the purposes of the present invention, the email application 18 that creates the single line of characters for the header field defined as “subject:” 36 (commonly referred to as the “subject line” of the email) would execute an alternative process 2 that programmatically inserts an appropriate next sequence marker 30 after the subject field name and colon that defines the header of subject line 36 and anywhere within the subject line 36. Thus, the next sequence marker 30 becomes embedded within and is part of email subject line 36. In addition to placing the next sequence marker 30 within the subject line 36 of the email message, the next sequence marker 30 could be inserted anywhere within the portion of the email that is visible to the recipient upon opening the email inbox in application 18; that is, in the areas reserved, pursuant to the specifications in RFC-5322 (and other RFC specifications for transporting email), for the name of the sender (known as “name:”) or near the beginning of the first text line of the body of the email.

Since in many email applications 18 the subject line 36 is immediately visible without the body of the email message being visible until the email message is actually opened, it is the best use of the present invention to have subject line 36 of the email be the location where the next sequence marker 30 would be inserted manually by Sender A using email application 18, or programmatically using process 2 and email application 18. Using the next sequential marker 30 in subject line 36 means it is easier for Recipient B to quickly and more easily identify a potential phishing attempt because Recipient B likely does not need to fully open email message 22 to see the next sequential marker 30. Application 18 and process 2 are configured to send email messages from computing device 12 to computing device 14 by extracting information from data source 20 (as a database or an accessible email history) and using the extracted information to fill various fields in email 22 before sending the email. For example, the email address 24 for Recipient B is extracted from data source 20 and inserted into the destination email address field 32 in email 22. In another embodiment of the present invention, Sender A manually reads information from data source 20 (as a database or an accessible email history) and manually fills in various fields in email 22, including using the next sequence marker 30 in the subject line 36 or in another part of the email, before sending the email using email application 18. Sender A could read the components of data source 20 (as a database or an accessible email history) to determine next sequence marker 30. In another embodiment of the present invention, Sender A could rely on other methods to track sequence identifier 26 and next sequence marker 30 for Recipient B and other contacts, such as (i) simply using human memory to track these; or (ii) tracking these using a written paper record; or (iii) tracking these using another database, computer application, or computer file stored on computing device 12 or another device or system accessible by Sender A; or (iv) tracking these using another method. In this alternative embodiment, instead of relying on process 2 to programmatically insert next sequence marker 30, Sender A could manually insert the next sequence marker 30 into the subject line 36, or into another part of the email, to help detect and prevent email phishing attempts by using sequential email numbering.

Email application 18, using process 2, also automatically inserts Sender A’s name (“sender’s name:” as defined in RFC-5322 and other protocols for transporting email) and email address 24 into the sender’s email address field (“Sender:” as defined in RFC-5322 and other protocols for transporting email) 34 and the original subject text of the email into the “subject:” 36 field. In an alternative embodiment of the present invention, Sender A would manually insert the data for these email fields while constructing the email message using email application 18.

Application 18, process 2, and data source 20 (as a database or an accessible email history) then operate together to retrieve the last sequence identifier 26 for that recipient from the components in data source 20 and generate a new next sequence marker 30 by, in this embodiment, arithmetically increasing it by one from 76 to 77. Process 2 then updates the sequence identifier for Recipient B in data source 20, if appropriate, and stores or saves the sequence identifier 26, or next sequence marker 30; or both sequence identifier 26 and next sequence marker 30; or a marker, indicator or other data to represent or compute at a later time the value for either sequence identifier 26 or next sequence marker 30, or both; pending retrieval for the next email from Sender A to Recipient B. Other database components in data source 20 about the history of previously sent emails from Sender A to Recipient B may also be stored in data source 20 (as a database 20 or an accessible email history), along with the sequence identifiers and sequence markers; however, if data source 20 takes the form of an email history, then it might not be necessary to store or save information about sequence identifier 26 or next sequence marker 30 in the database components since the email history can simply be read when needed by Sender A or process 2 to determine what the sequence identifier 26 is and what the next sequence marker 30 will be.

When Sender A’s email application 18 communicates to the Company’s email domain 37, it may comply with IMF and SMTP, or it may use an alternate protocol, standard or proprietary method for transporting email. Alternatively, a web browser application may be used to communicate to an internet host that is coupled to the Company’s email domain 37. In either case, the precise communication method between application 18 and the Company’s domain 37 is not material for the purposes of the present invention. Regardless of how Sender A’s application 18 and the Company’s email domain 37 communicate, as the email leaves its host domain by means of SMTP, a simple, stripped-down IMF email in US-ASCII characters will look similar to this, as an example:
Sender: senderA.address@Companydomain.com
Message-ID: <000000000c5d058363538e@senderAdomain.com>
Date: Wed, 06 Mar. 2019 01:58:25 +0000
Subject: Contributions for next week’s webinar?
From: <senderA.address@Companydomain.com>
To: recipientB@Companydomain.com
Body: Melissa wants to know if we are going to give a progress report on our project, or wait for a while. Thoughts?

This above example, along with the examples below, is intended to show the header fields of a typical email message 22. These examples are presented in US-ASCII characters. RFC-5322 specifies that email “messages are made up of characters in the US-ASCII range of 1 through 127. There are other documents, specifically the MIME document series ([RFC2045], [RFC2046], [RFC2047], [RFC2049], [RFC4288], [RFC4289]), that extend this specification to allow for values outside of that range” (Section 2.1). Therefore, the present invention can utilize either US-ASCII characters, or the other data types or character sets in other standards that allow for values outside of the US-ASCII range of 1 through 127, to detect an email phishing attempt or fraudulent email using sequential email numbering.

If the next sequence marker 30 in the present invention has been applied (to the “subject:” line 36 in this example), the simple email IMF example will look like this as it leaves the Company’s domain 37 by means of SMTP:
Sender: senderA.address@Companydomain.com
Message-ID: <000000000c5d058363538e@senderAdomain.com>
Date: Wed, 06 Mar. 2019 01:58:25 +0000
Subject: 77 - Contributions for next week’s webinar?
From: <senderA.address@Companydomain.com>
To: recipientB@Companydomain.com
Body: Melissa wants to know if we are going to give a progress report on our project, or wait for a while. Thoughts?

In another example, the next sequence marker 30 in the present invention has been applied to the “subject:” line 36, but is not strictly at the beginning of the subject line:
Sender: senderA.address@senderAdomain.com
Message-ID: <000000000c5d058363538e@senderAdomain.com>
Date: Wed, 06 Mar. 2019 01:58:25 +0000
Subject: Contributions for next week’s webinar? - 77
From: <senderA.address@Companydomain.com>
To: recipientB@Companydomain.com
Body: Melissa wants to know if we are going to give a progress report on our project, or wait for a while. Thoughts?

This example demonstrates that the next sequential identifier 30 could be inserted within the subject line 36 immediately after the header (“Subject :”) or anywhere within the subject line 36, including in the middle or at the end of the subject line 36. The next sequence marker 30 is thus added to the original text intended for the “subject:” line 36 and the combined text is inserted into the “subject:” line 36. The next sequence marker 30 could be at the beginning of the text of the subject line, anywhere within the subject line text, or at the end of the subject line text, as demonstrated in the following three examples: (i) Subject: 77 — Contributions for next week’s webinar? (ii) Subject: Contributions for next week’s webinar? — 77; and (iii) Subject: Contributions — 77 — for next week’s webinar? The present invention inserted next sequence marker 30 into the email subject line 36, programmatically by process 2, when email message 22 was created by Sender A with the interoperable data source 20 (as a database or an accessible email history) and email application 18. In another embodiment of the present invention, Sender A could have determined the next sequence marker 30 by referencing the components in data source 20 and manually creating an email message using email application 18 (without using process 2) and manually inserting the next sequence marker 30 within the subject line 36. In further embodiments, other applications running on the email server or interoperating with the email domain 37 could have intercepted the email at a later stage and inserted the next sequence marker 30 programmatically, prior to the email being transmitted to the recipient, if no sequence marker 30 was found in the subject line 36 or in another email message header field, message body, or any other part of the email message. Furthermore, the next sequence marker 30 is not limited to being in subject line 36 and so it could be placed: (i) anywhere within the sender’s name field (“Sender:”) which, as described in RFC-5322, Section 3.4, is an email header field for “an optional display name ... (which can be a person or a system) that could be displayed to the user of a mail application”; or (ii) somewhere within the beginning of the body of the email message, because often this area is used for preview text (e.g., where the first few characters of the email body are visible without opening the full email message); or (iii) in other areas within the body field of the email message, such that the human user (in this case Recipient B) would be assisted to recognize and comprehend the significance of the sequence identifier within his email inbox without requiring any other process; or (iv) in any other part of the email message, whether visible or invisible to the human end-user, including in required header fields, or in optional header fields, or in the body of the email message, so long as inclusion of the next sequence marker 30 in a given location does not interfere with the syntax or other requirements of the email message components, and does not materially interfere with the proper functioning of email messaging using the RFC-5322 protocol and other standards for transporting email; or (v) into a separate, custom application, whether proprietary or sourced from a third party, that has been configured to meet the Company’s email sending needs.

All of these placement locations for next sequence marker 30 are suitable for use with RFC-5322 since the protocol allows for substantial customizability and extensibility, because “The only required header fields are the origination date field and the originator address field(s). All other header fields are syntactically optional” (Section 3.6) and, furthermore, “This specification is not intended to dictate the internal formats used by sites, the specific message system features that they are expected to support, or any of the characteristics of user interface programs that create or read messages. In addition, this document does not specify an encoding of the characters for either transport or storage” (Section 1.1).

Although the next sequence marker 30 could be inserted anywhere within the email 22, as described above, if the next sequence marker 30 were located within subject line 36, this would be in keeping with the RFC protocols and related standards for email messaging: as set forth in RFC-5322, Section 3.6.5, the subject line 36 is “intended to have only human-readable content with information about the message” and so acts an appropriate container for next sequence marker 30 and allows the present invention to function properly without deviating from RFC-5322 and related standards for transporting email messages.

The present invention assists its human users in recognizing and understanding the significance of sequence identifier 26 and sequence marker 30 (which in this embodiment are similar to page numbers). Once the human user has recognized or learned of the significance of the sequence identifier(s), no further or prior specialized knowledge is required. Recipient B may be assisted in understanding that an email purporting to be from Sender A but that is lacking either the correct next sequence marker 30 or any sequence marker at all may be a phishing or fraud attempt and should be considered to be suspicious and worthy of further investigation. This assistance could come if some combination of email application 18, data source 20 (as a database or an accessible email history) and process 2 alerted Recipient B if the next sequential marker 30 that was received as part of email message 22 did not match the expected sequential identifier; that is, if the sequence were out of order. Email application 18, interoperating with other components, could, for example, change the email message to a different colour, alert Recipient B using an on-screen message on computing device 14, or otherwise provide a notification to Recipient B that an email might be a potential email phishing attempt and should be treated as a suspicious email message. Recipient B could also instead manually compare the next sequence marker 30 to sequence identifier 26 to determine whether an email is a potential phishing or fraud attempt. The present invention thus allows Recipient B, an authorized user of a corporate email domain, to detecting email phishing attempts, or other fraudulent emails, using sequential email numbering and the other components and processes of the present invention.

In another embodiment of the present invention, Sender A’s outgoing emails, including emails being sent to contacts outside of Sender A’s email domain 37, are sequentially numbered so such external contacts may benefit from sequential email numbering to detect phishing attempts and/or other fraudulent emails. In this embodiment, even though the external recipient may not be within the same email domain as Sender A, sequential email numbering may help the external recipient notice potential phishing attempts where a bad actor may be impersonating Sender A or another email sender within Sender A’s email domain 37. In this embodiment, the external recipient’s email application or email domain may or may not have the ability to automatically flag suspicious emails, depending on whether this external email domain also uses the sequential email numbering and other components and processes of the present invention.

In another embodiment of the present invention, namely intercepting the email at the sender’s email domain 37, the email domain 37 may insert the next sequence marker 30 if no sequence identifier is detected in a sender’s email, thus providing the email domain’s user base with the means to identify and prevent email phishing attempts.

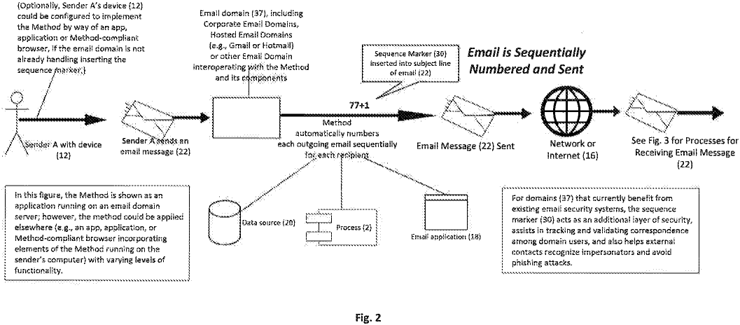

FIG. 2 depicts components of and processes for sending email with the method of using sequential email numbering to detect email phishing attempt or fraudulent emails within email domains (37), including corporate email domains, hosted email domains (e.g., Gmail™ or Hotmail™) or other email domains interoperating with the method and its components. The method components automatically number each outgoing email sequentially for each email recipient. Sequence marker (30) is inserted into the subject line of each outgoing email (22) for that domain (37), resulting in emails being sequentially numbered and sent at the domain level.

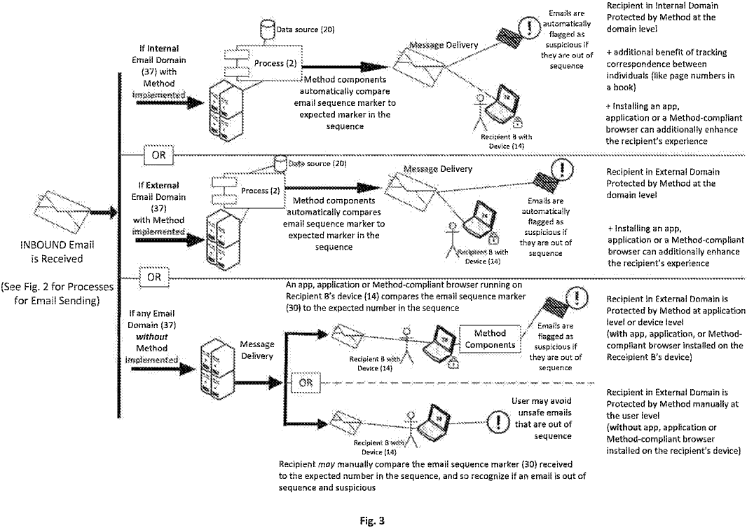

FIG. 3 depicts components of and processes for receiving email with the method of using sequential email numbering to detect email phishing attempts or fraudulent emails within email domains. There are variations in the process, depending on whether the email is received by an email domain that implements the method at the domain level, at the application or device level, or at the recipient level:

(a) When an email is received within the same or “internal” email domain (37) that sent the message, since that internal domain implements the method at the domain level, the components automatically compare the email sequence marker to the expected marker in the sequence and emails are automatically flagged as suspicious phishing or fraud attempts if they are out of sequence.

(b) When an email is received within a different or “external” email domain (37) than that which sent the message, since that external domain also implements the method at the domain level, the components automatically compare the email sequence marker to the expected marker in the sequence and emails are automatically flagged as suspicious phishing or fraud attempts if they are out of sequence.

(c) When an email is received within a different or “external” email domain (37) than that which sent the message, if that external domain does not implement the method at the domain level, then an app, application or method-compliant browser running on Recipient B’s device (14) may still compare the email sequence marker (30) to the expected number in the sequence and emails are automatically flagged as suspicious phishing or fraud attempts if they are out of sequence. But, when an email is received within a different or “external” email domain (37) than that which sent the message, if that external domain does not implement the method at the domain level and there is not an app, application or method-compliant browser running on Recipient B’s device (14), the Recipient B may still notice and manually compare the email sequence marker (30) to the expected number in the sequence and emails that are out of sequence may be avoided, keeping the recipient safe even if the email is not automatically flagged as a suspicious phishing or fraudulent email attempt.

The present invention has several advantages for corporate entities using the domain variant within its organization. Firstly, sequential numbering within an email domain is a system where each record or document is assigned a unique and consecutive number based on the order in which it was created and sent by a user. Corporate domain email environments are uniquely positioned to benefit from sequential email numbering because the email numbering occurs inside the boundaries of the organization’s own email handling systems and because all incoming and outgoing messages are handled by the organization’s centralized system, helping guarantee the accuracy of the sequential numbering. In domain environments both email senders’ and recipients’ email messages are handled within the organization’s security and email systems, so organizations can benefit immediately from sequential email numbering without requiring the adoption of the method by any third party. Outgoing emails destined for external email addresses can still all be numbered within the domain method to help protect their client bases from phishing, fraud, impersonation, and incomplete record sets.

This sequence ID number serves as an identifier for the record and can be used to track and locate it easily, providing significant benefits to an organization in email record keeping. When an organization works with a large volume of email message records, it can be challenging for people within the organization to locate a particular document quickly. However, if each record is assigned a unique number, and the number is found in a human-readable field within the email message and is easily understandable by a human, it becomes easier for users to access and retrieve email message records based on their unique, sequential ID number. This can save time and effort, especially in busy workplaces where employees may have to handle multiple tasks simultaneously. It can also improve worker efficiency within an organization that uses email numbering in its email domain.

Furthermore, sequential email numbering in a domain environment can help to reduce errors in email message record keeping. When each record is assigned a unique identifier, it becomes easier to track and monitor the progress of a particular task or project or conversation. This can help to ensure that no email message is misplaced or forgotten, leading to improved accuracy in record keeping.

Sequential numbering can also improve an organization’s communication. When all team members are referring to the same email message ID number, it becomes easier to discuss specific tasks or projects without confusion or misunderstandings. This can help to improve collaboration and productivity among team members.

Moreover, sequential numbering allows an organization to track the chronological order of email message records. This is particularly useful when dealing with legal or regulatory compliance issues where maintaining accurate records is critical. By assigning sequential numbers, organizations can ensure that they can provide a complete and accurate record of all their activities, which is essential when facing audits or investigations.

Sequential numbering can also help to improve the security of email message records. When documents are assigned unique numbers, it becomes easier to detect missing or misplaced or potentially fraudulent extraneous email messages. This can help to prevent unauthorized access to sensitive information, which is crucial for organizations that deal with confidential data.

Finally, by adopting this email domain sequential numbering approach, organizations can streamline their processes, increase productivity, and ensure compliance with legal and regulatory requirements and gain value from adding numbering to their existing email communication systems. If two corporations share the same email domain they have the same protection of and benefits of sequential email numbering as set forth above.

In the case of web based email providers such as HOTMAIL, all users (as all being behind the same firewall/security perimeter) would be protected by the domain email numbering method. Any user sending to any other HOTMAIL user can be assured of the same safety and benefits as above (and benefits, once the method is deployed, can be realized immediately)

A specific embodiment of the present invention has been disclosed; however, several variations of the disclosed embodiment could be envisioned as within the scope of this invention. It is to be understood that the present invention is not limited to the embodiments described above but encompasses any and all embodiments within the scope of the following claims.

Therefore what is claimed is:

1. A method of verifying the authenticity of emails sent from a sender to a recipient, the method comprising the steps of:
Providing a server on a secure network with an email processing application located thereon for processing emails sent and received within the secure network;
Providing an email send/receive application to both the sender and the recipient, the send/receive applications of both the sender and recipient being coupled to the secure network and the email send/receive application;
The email processing application and the email send/receive application configured to recognize emails having a sender’s email address, a receiver’s email address, and a user accessible field for receiving content, the email addresses having a name portion and a domain portion, the domain portions of the email addresses being identical, the content of the user accessible field being visible to the recipient upon opening an email inbox in the email send/receive application;
Identifying the receiver for an email to be sent by the sender;
generating a current sequence marker for the receiver, the current sequence marker representing a next sequence identifier in a sequence of emails between the sender and the receiver;
inserting the current sequence marker into the user-accessible field of the email and then sending the email to the recipient, and
wherein the sender queries an email history to generate the current sequence marker, the email history representing a record of emails previously sent from the sender to the recipient, the sender then inserting the current sequence marker into the user accessible field before sending the email.

2. The method of claim 1 wherein the current sequence marker comprises one or more characters selected from the group of sequential characters comprising letters, numbers, words from a sequential list of words, symbols from a sequential list of symbols, icons from a sequential list of icons and images from a sequential list of images.

3. The method of claim 1 wherein the email history is contained in a database located on the server and coupled to the email processing application.

4. The method of claim 3 wherein the database and email processing application are configured to programmatically generate the current sequence marker and insert it into the user accessible field before sending the email.

5. The method of claim 1 wherein the email history includes a last sequence marker for a last email sent to the recipient, the sender generating the current sequence marker by incrementing the last sequence marker by 1.

6. The method of claim 1 wherein the user accessible field into which the current sequence marker is inserted is a subject field for the email.

7. The method of claim 5 further comprising the steps of the recipient receiving the email sent by the sender, the current sequence marker being identified from the email, the current sequence marker then being compared to an expected sequence marker predicted from the last sequence marker, the email being flagged as suspicious if the current sequence marker identified from the email does not match the expected sequence marker.

8. The method of claim 1 wherein the current sequence marker is a human readable alphanumeric sequence of characters.

9. The method of claim 1 wherein the sender and recipient are each remotely located relative to the server, the method further comprising the step of the sender and recipient each logging into the secure network by providing a combination of names and passwords to the secure network, the combination of names and passwords being unique to each of the sender and recipient.
